(19) United States
(12) Patent Application Publication
(10) Pub. No.: US 2021/0033091 A1
(43) Pub. Date: Feb. 4, 2021

(54) OIL PUMP

(71) Applicant: YAMADA MANUFACTURING CO., LTD., Kiryu-shi (JP)

(72) Inventors: Kazuhiro Arai, Kiryu-shi (JP); Kosuke Sato, Kiryu-shi (JP); Sentaroh Nishioka, Kiryu-shi (JP)

(21) Appl. No.: 16/929,677

(22) Filed: Jul. 15, 2020

(30) Foreign Application Priority Data
Aug. 1, 2019 (JP) 2019-142541
May 26, 2020 (JP) 2020-091698

(51) Int. Cl. F04C 14/24; F04C 15/06

(52) U.S. Cl. CPC F04C 14/24; F16H 57/0436; F04C 15/064

(57) ABSTRACT

An oil pump includes a rotation shaft, a pump unit including an inner rotor and an outer rotor, and a casing provided with a pump chamber accommodating the pump unit, wherein at least one of a first suction passage, a first ejection passage, a second suction passage, and a second ejection passage of the casing includes a check valve provided in the oil carrying passage and the check valve includes a ball and a seating portion allowing the ball to be seated thereon and does not use a spring.

### BACKGROUND OF THE INVENTION

### Field of the Invention

The present invention relates to an oil pump which is used in internal combustion engines, transmissions, differential gear units, transaxles, and the like of automobiles and the like.

Priority is claimed on Japanese Patent Application No. 2019-142541 filed on Aug. 1, 2019 and Japanese Patent Application No. 2020-091698 filed on May 26, 2020, and the contents are incorporated herein by reference.

### Description of Related Art

An oil pump for lubricating each lubricated part is provided in internal combustion engines, transmissions, differential gear units, transaxles, and the like of automobiles and the like. For example, a trochoid type (internal gear) oil pump sucks and ejects oil by increasing and decreasing a capacity of a void formed between an outer rotor and an inner rotor accommodated in a pump chamber.

Patent Document 1 (Japanese Unexamined Patent Application, First Publication No. H06-20951) describes a trochoid type oil pump capable of ejecting oil to perform sufficient lubrication regardless of whether a shaft rotating an inner rotor rotates in a certain direction or rotates in the opposite direction. The oil pump described in Patent Document 1 can suck and eject oil regardless of whether the shaft rotates in a forward direction or a backward direction and can pressure-feed oil to each lubricated part, for example, regardless of whether an automobile travels forward or backward.

### SUMMARY OF THE INVENTION

However, since the oil pump described in Patent Document 1 used a spring for a check valve, it was difficult to realize further space saving.

In view of the above-described circumstances, an object of the present invention is to provide an oil pump capable of pressure-feeding oil regardless of whether a shaft rotates forward or backward and realizing space saving.

In order to solve the above-described problems, this invention proposes the following means.

(1) An oil pump according to a first aspect of the present invention includes: a casing which is provided with a pump chamber; a rotation shaft which is rotatably supported by the casing; and a pump unit which is accommodated inside the pump chamber and is configured to send out oil inside the pump chamber in accordance with the rotation of the rotation shaft, wherein the casing includes a first suction port which communicates with the pump chamber, a first suction passage which communicates with the first suction port, a first ejection port which communicates with the pump chamber, a first ejection passage which communicates with the first ejection port, a second suction port which communicates with the pump chamber, a second suction passage which communicates with the second suction port, a second ejection port which communicates with the pump chamber, and a second ejection passage which communicates with the second ejection port, wherein, when the pump unit rotates in one direction, the first suction port is configured to suck the oil from the first suction passage to the pump chamber and the first ejection port ejects the oil to the first ejection passage, wherein when the pump unit rotates in the other direction, the second suction port is configured to suck the oil from the second suction passage to the pump chamber and the second ejection port ejects the oil to the second ejection passage, and wherein at least one of the first suction passage, the first ejection passage, the second suction passage, and the second ejection passage includes a check valve provided in the oil carrying passage and the check valve includes a ball and a seating portion allowing the ball to be seated thereon and does not use a spring.

According to this aspect, the oil pump can pressure-feed oil regardless of whether the rotation shaft rotates forward or backward. Further, the check valve having a simple structure is used as the oil check valve, parts requiring a large space such as a spring are not required, and hence space saving can be realized.

(2) In the aspect (1), the first suction port, the first ejection port, the second suction port, and the second ejection port may be disposed at a position in which a vertical height is the same.

According to this aspect, the dimension in the height direction can be shortened compared to a case in which the four ports have different heights.

(3) In the aspect (1) or (2), the first suction port and the first ejection port may be formed on both sides with the pump chamber interposed therebetween and the second suction port and the second ejection port may be disposed on both sides with the pump chamber interposed therebetween.

According to this aspect, the four ports can be arranged in a well-balanced manner and the entire dimension of the oil pump can be decreased.

(4) In any one of the aspects (1) to (3), the casing may include a casing main body and a casing cover, the pump chamber may be formed between the casing main body and the casing cover, the first suction port and the first ejection port may be provided in the casing main body, and the second suction port and the second ejection port may be provided in the casing cover.

According to this aspect, space saving can be realized compared to a case in which all of the four ports are provided in any one of the casing main body and the casing cover.

(5) In any one of the aspects (1) to (4), at least one of the check valves may be provided in a passage that is configured to carry the oil in a vertical direction.

According to this aspect, since the ball constituting the check valve naturally moves to the seating portion due to the own weight of the ball, the configuration of the check valve can be simplified.

(6) In any one of the aspects (1) to (4), at least one of the check valves may include an inclined surface which is configured to guide the ball to the seating portion.

According to this aspect, the ball is moved to the seating portion while being guided by the inclined surface due to the hydraulic pressure of the oil or the own weight of the ball. Thus, the ball can be smoothly moved by the inclined surface. For this reason, the configuration of the check valve can be simplified.

According to the oil pump of the present invention, it is possible to pressure-feed oil regardless of whether the shaft rotates forward or backward and to realize space saving.

### BRIEF DESCRIPTION OF THE DRAWINGS

FIG. 1 is an exploded view of an oil pump according to a first embodiment.

FIG. 2 is a cross-sectional view of the oil pump in the X direction.

FIG. 3 is a front view and a cross-sectional view of a casing main body as viewed from a pump unit of the oil pump.

FIG. 4 is a front view and a cross-sectional view of a casing cover as viewed from the pump unit of the oil pump.

FIG. 5 is a front view of the pump unit of the oil pump.

FIG. 6 is a diagram showing a check valve of a first ejection passage or the like through which oil passes.

FIG. 7 is a diagram showing a modified example of the check valve.

FIG. 8 is a front view of a casing main body as viewed from a pump unit of an oil pump according to a second embodiment.

FIG. 9 is a front view of a casing cover as viewed from the pump unit of the oil pump.

FIG. 10 is a front view of the pump unit of the oil pump.

### DETAILED DESCRIPTION OF THE INVENTION

### First Embodiment

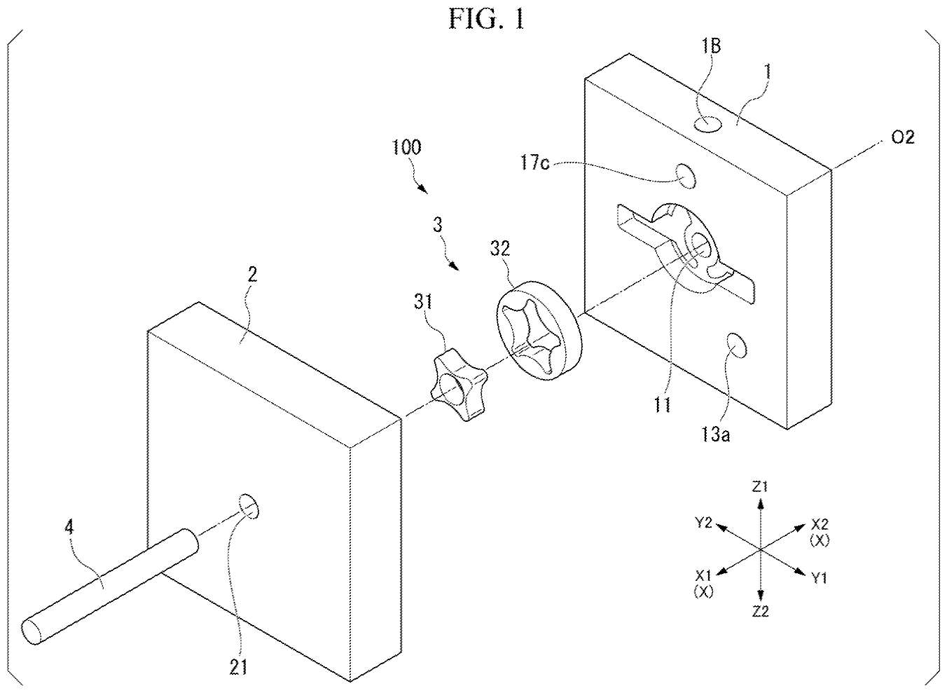

An embodiment of the present invention will be described with reference to FIGS. 1 to 6. An oil pump 100 according to this embodiment is mounted on, for example, an engine room of a vehicle, particularly, a differential gear unit or the like. The oil pump 100 pumps oil from an oil pan in accordance with the rotation of an engine and sends out the oil to a lubricating member, a cooling member, a hydraulic device, and the like corresponding to oil supply targets. Additionally, the oil pump 100 may be mounted on other than a vehicle.

<Oil Pump 100>

FIG. 1 is an exploded view of the oil pump 100 according to this embodiment.

The oil pump 100 is a so-called trochoid type (internal gear) oil pump and includes a casing 10, a pump unit 3, and a rotation shaft 4. In the following description, the extension direction of the rotation shaft 4 will be described as the X direction, the vertical direction in which oil is pumped up to the oil pump 100 will be described as the

Z direction, and the horizontal direction orthogonal to the X direction and the Z direction will be described as the Y direction.

<Rotation Shaft 4>

The rotation shaft 4 is connected to the propeller shaft of the engine. By the rotation of the propeller shaft, the rotation shaft 4 rotates with the X direction as the rotation shaft direction to rotate the inner rotor 31. Additionally, the rotation shaft 4 can be connected to an arbitrary member such as a cam shaft in addition to a crank shaft. In the following description, the axis of the rotation shaft 4 will be referred to as an “axis O2”.

<Casing 10>

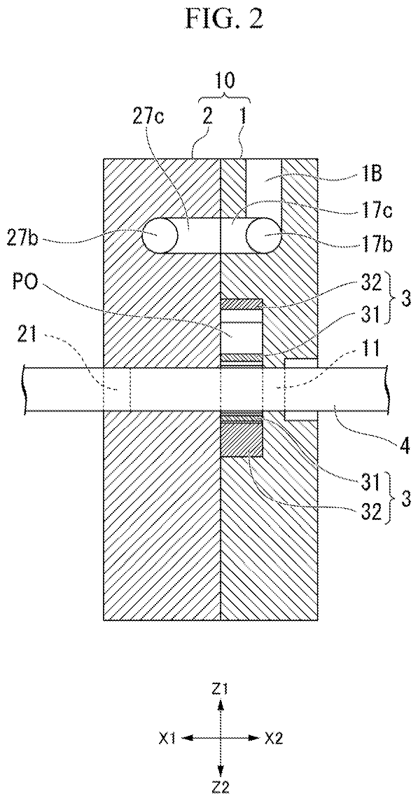

FIG. 2 is a cross-sectional view of the oil pump 100 in the X direction.

The casing 10 includes a casing main body 1 and a casing cover 2. The casing main body 1 and the casing cover 2 are bonded and fixed to each other and a pump chamber PO is formed between the casing main body 1 and the casing cover 2. The pump unit 3 is disposed in the pump chamber PO. The rotation shaft 4 penetrates the casing main body 1 and the casing cover 2.

<Casing Main Body 1>

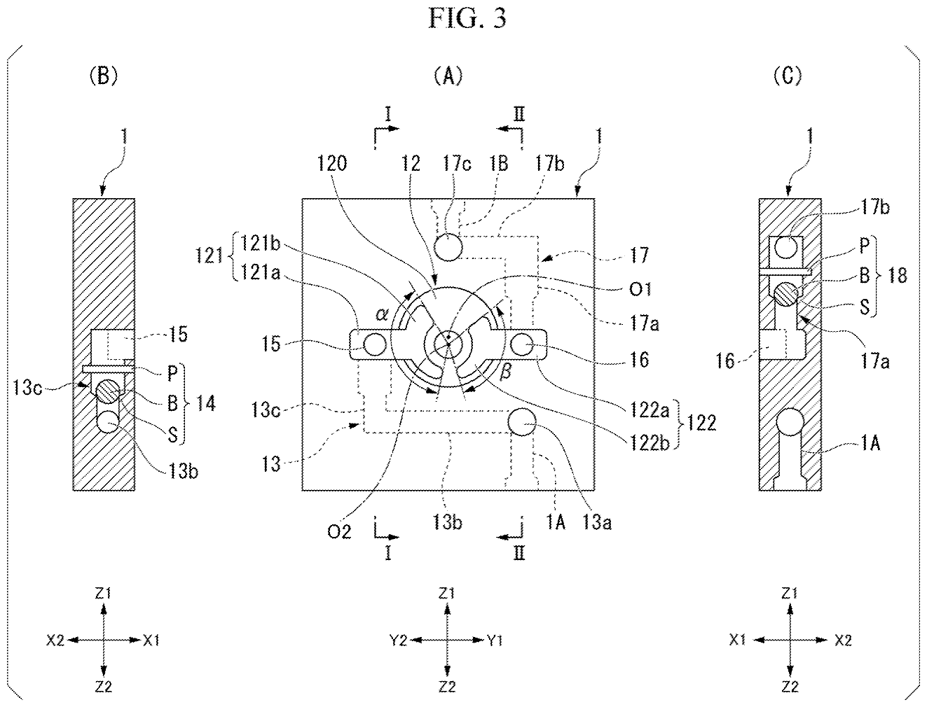

FIG. 3(A) is a front view of the casing main body 1 as viewed from the side of the pump unit 3. FIG. 3(B) is a cross-sectional view of a cross-section I-I of the casing main body 1 shown in FIG. 3(A). FIG. 3(C) is a cross-sectional view of a cross-section II-II of the casing main body 1 shown in FIG. 3(A).

The casing main body 1 is formed in a box shape and includes a main body side rotation shaft insertion hole 11, a main body side concave portion 12, a first suction passage 13, a first suction port 15, a first ejection port 16, a first ejection passage 17, an oil suction port 1A, and an oil outlet 1B.

The main body side rotation shaft insertion hole 11 (see FIG. 2) is a hole that penetrates the casing main body 1 in the X direction and the rotation shaft 4 is inserted thereinto. The outer diameter of the rotation shaft 4 is slightly smaller than the inner diameter of the main body side rotation shaft insertion hole 11 and the rotation shaft 4 can rotate while penetrating the main body side rotation shaft insertion hole 11.

The main body side concave portion 12 is a concave portion that opens to a first side of the X direction (hereinafter, referred to as an “X1 direction”). The main body side concave portion 12 includes a pump accommodation portion 120, a first suction groove portion 121, and a first ejection groove portion 122. The main body side concave portion 12 forms an outer shell of the pump chamber PO along with a cover side concave portion 22 to be described later.

The pump accommodation portion 120 is an area where the pump unit 3 is accommodated. The pump accommodation portion 120 is formed as a cylindrical space in such a manner that the inner peripheral surface is formed in a circular shape around the axis O1 as viewed from the X direction. The axis O1 is parallel to the axis O2. The main body side rotation shaft insertion hole 11 is formed around the axis O2 shifted from the axis O1 as viewed from the X direction.

The first suction groove portion 121 is a groove portion that is depressed to the side opposite to the first side of the X direction (hereinafter, referred to as an “X2 direction”) and is a path that carries oil to the pump accommodation portion 120. The first suction groove portion 121 is further depressed in the X2 direction compared to the pump accommodation portion 120. The first suction groove portion 121 includes a straight groove portion 121a and an arc groove portion 121b.

The straight groove portion 121a is formed in a straight shape along the Y direction as shown in FIG. 3. The main body side rotation shaft insertion hole 11 is located at a first side (hereinafter, referred to as an “Y1 direction”) of the Y direction of the first straight groove portion.

The arc groove portion 121b is formed in an end portion of the straight groove portion 121a in the Y1 direction and is formed in an arc shape along the main body side rotation shaft insertion hole 11. The groove width of the arc groove portion 121b as viewed from the X direction becomes wider as it goes clockwise around the axis O2.

The first ejection groove portion 122 is a groove portion that is depressed in the X2 direction and is a path that carries oil from the pump accommodation portion 120. The first ejection groove portion 122 is further depressed in the X2 direction compared to the pump accommodation portion 120. The first ejection groove portion 122 includes a straight groove portion 122a and an arc groove portion 122b.

The straight groove portion 122a is formed in a straight shape along the Y direction as shown in FIG. 3. The main body side rotation shaft insertion hole 11 is located at the opposite side (hereinafter, referred to as an “Y2 direction”) to the first side of the Y direction of the straight groove portion 122a.

The arc groove portion 122b is formed in an end portion of the straight groove portion 122a in the Y2 direction and is formed in an arc shape along the main body side rotation shaft insertion hole 11. The groove width of the arc groove portion 122b as viewed from the X direction becomes wider as it goes counterclockwise around the axis O2. The circumferential angle β of the arc groove portion 122b is smaller than the circumferential angle α of the arc groove portion 121b.

The first suction passage 13 is a passage that carries oil to the first suction port 15. The first suction passage 13 includes a first suction port 13a, a first suction first passage 13b, and a first suction second passage 13c. The first suction second passage 13c is provided with a first suction passage check valve 14 formed therein.

The first suction port 13a is an opening formed in the casing main body 1 and opens in the X1 direction. The first suction port 13a is an opening into which oil pumped from the oil pan through the oil suction port 1A enters. The first suction port 13a communicates with the first suction first passage 13b. Further, the first suction port 13a communicates with a second suction port 23a to be described later. The oil suction port 1A is an opening formed in the casing main body 1 and opens in the Z2 direction.

The first suction first passage 13b is a passage which carries oil supplied from the oil suction port 1A in the Y2 direction. The first suction first passage 13b communicates with the first suction second passage 13c.

The first suction second passage 13c is a passage which carries oil supplied from the first suction first passage 13b to a first side (hereinafter, referred to as a “Z1 direction”) corresponding to the upper side of the Z direction. The first suction second passage 13c communicates with the first suction port 15. The first suction second passage 13c is provided with the first suction passage check valve 14 formed therein.

The first suction passage check valve 14 is a check valve through which oil can flow in the Z1 direction and which limits a backflow to the opposite side (hereinafter, referred to as a “Z2 direction”) of the Z1 direction. The first suction passage check valve 14 includes a ball B, a seating portion S, and a pin P.

The seating portion S is an annular portion provided in the inner peripheral surface of the first suction second passage 13c. The inner diameter of the seating portion S is smaller than the outer diameter of the ball B and the ball B cannot pass through the inside of the seating portion S. Since the ball B and the seating portion S contact each other without a gap therebetween when the ball B comes into contact with the inner peripheral edge of the seating portion S, oil does not flow in the Z2 direction. When the oil flows in the Z1 direction, the ball B floats above the seating portion S and the oil flows in the Z1 direction.

The pin P is formed in a small columnar shape and is provided in the Z1 direction in relation to the seating portion S in the first suction second passage 13c. The pin P closes a part of the oil passage in the first suction second passage 13c. The pin P prevents (suppresses) a case in which oil contacts the floating ball B and the ball B flows in the Z1 direction over the pin P when the oil flows in the Z1 direction. Additionally, a mesh or the like other than the pin P may be used as a member that regulates the movement of the ball B.

The first suction port 15 is disposed in the Y2 direction with respect to the pump chamber PO. The first suction port 15 is an opening through which oil is sucked from the first suction passage 13 to the pump chamber PO and opens in the X1 direction on the bottom surface of the straight groove portion 121a. Oil ejected from the first suction port 15 is sent to the pump accommodation portion 120 through the first suction groove portion 121.

The first ejection port 16 is disposed in the Y1 direction with respect to the pump chamber PO. The first ejection port 16 is an opening through which oil is ejected from the pump chamber PO and opens in the X1 direction on the bottom surface of the straight groove portion 122a. Oil ejected from the pump accommodation portion 120 is ejected from the first ejection port 16 to the first ejection passage 17 through the first ejection groove portion 122.

The first ejection passage 17 is a passage which carries oil from the first ejection port 16. The first ejection passage 17 is disposed at a position that is point-symmetrical with respect to the first suction passage 13 around the axis O1. The first ejection passage 17 includes a first ejection first passage 17a, a first ejection second passage 17b, and a first ejection port 17c.

The first ejection first passage 17a is a passage which carries oil ejected from the first ejection port 16 in the Z1 direction. The first ejection first passage 17a communicates with the first ejection second passage 17b. The first ejection first passage 17a is provided with a first ejection passage check valve 18.

The first ejection passage check valve 18 has the same configuration as that of the first suction passage check valve 14 except that the first ejection passage check valve is provided in the first ejection first passage 17a and includes a ball B, a seating portion S, and a pin P.

The first ejection second passage 17b is a passage which carries oil supplied from the first ejection first passage 17a in the Y2 direction. Oil ejected from the first ejection second passage 17b is pressure-fed from the oil outlet 1B to a lubricating member of a differential gear or the like. The oil outlet 1B is an opening formed in the casing main body 1 and opens in the Z1 direction. The first ejection second passage 17b communicates with the first ejection port 17c. The first ejection port 17c is an opening formed in the casing main body 1 and opens in the X1 direction.

<Casing Cover 2>

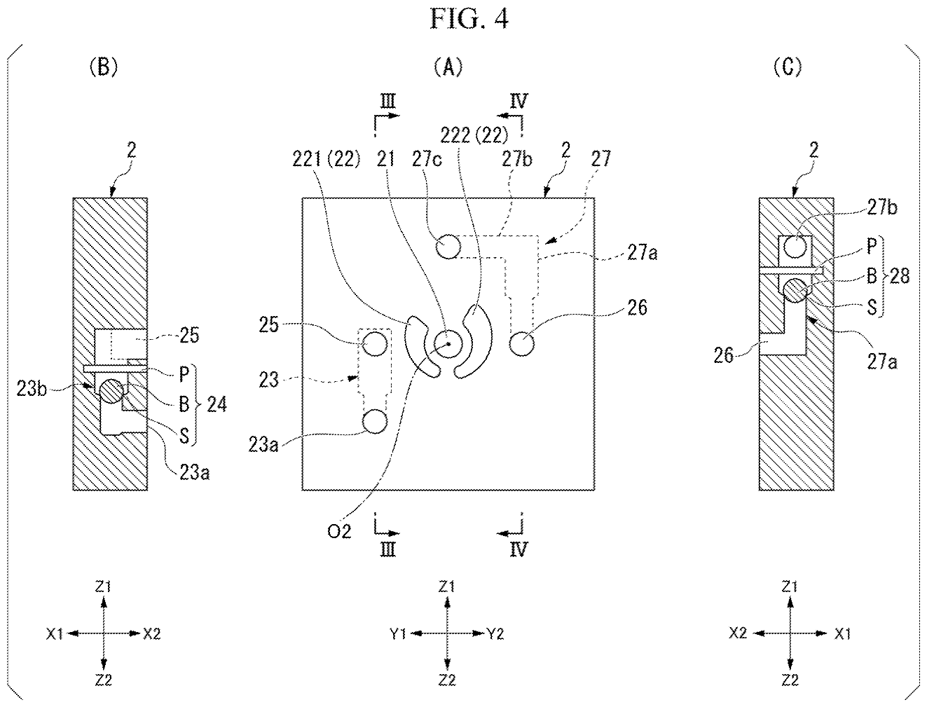

FIG. 4(A) is a front view of the casing cover 2 as viewed from the side of the pump unit 3. FIG. 4(B) is a cross-sectional view of a cross-section of the casing cover 2 shown in FIG. 4(A). FIG. 4(C) is a cross-sectional view of a cross-section IV-IV of the casing cover 2 shown in FIG. 4(A).

The casing cover 2 is formed in a box shape and includes a cover side rotation shaft insertion hole 21, a cover side concave portion 22, a second suction passage 23, a second suction port 25, a second ejection port 26, and a second ejection passage 27.

The cover side rotation shaft insertion hole 21 is a hole which penetrates the casing cover 2 in the X direction and into which the rotation shaft 4 is inserted. The outer diameter of the rotation shaft 4 is slightly smaller than the inner diameter of the cover side rotation shaft insertion hole 21 and the rotation shaft 4 can rotate while penetrating the cover side rotation shaft insertion hole 21.

The cover side concave portion 22 is a concave portion opening in the X2 direction. The cover side concave portion 22 includes a second suction groove portion 221 and a second ejection groove portion 222. The cover side concave portion 22 forms an outer shell of the pump chamber PO along with the main body side concave portion 12.

The second suction groove portion 221 is a groove that is depressed in the X1 direction and is a path that carries oil to the pump accommodation portion 120. The second suction groove portion 221 is formed in an arc shape along the cover side rotation shaft insertion hole 21. The groove width of the second suction groove portion 221 as viewed from the X direction becomes wider as it goes clockwise around the axis O2.

The second ejection groove portion 222 is a groove that is depressed in the X1 direction and is a path that carries oil from the pump accommodation portion 120. The second ejection groove portion 222 is formed in an arc shape along the cover side rotation shaft insertion hole 21. The groove width of the second ejection groove portion 222 as viewed from the X direction becomes wider as it goes counterclockwise around the axis O2.

The second suction passage 23 is a passage which carries oil to the second suction port 25. The second suction passage 23 extends to the side opposite to the first ejection passage 17 (the Z2 direction) with respect to the straight groove portion 122a. The second suction passage 23 includes a second suction port 23a and a second suction first passage 23b. The second suction first passage 23b is provided with a second suction passage check valve 24.

The second suction port 23a is an opening formed in the casing cover 2 and opening in the X2 direction. The second suction port 23a is an opening into which oil pumped from the oil pan through the oil suction port 1A enters. The first suction port 13a communicates with the first suction first passage 13b. Further, the second suction port 23a is disposed to be able to communicate with the first suction port 13a in a facing state.

The second suction first passage 23b is a passage which carries oil supplied from the second suction port 23a in the Z1 direction. The second suction first passage 23b communicates with the second suction port 25. The second suction first passage 23b is provided with a second suction passage check valve 24.

The second suction passage check valve 24 has the same configuration as that of the first suction passage check valve 14 except that the second suction passage check valve is provided in the second suction first passage 23b and includes a ball B, a seating portion S, and a pin P.

The second suction port 25 is disposed in the Y1 direction with respect to the pump chamber PO. The second suction port 25 is an opening through which oil is sucked from the second suction passage 23 to the pump chamber PO and opens in the X2 direction at a position facing the straight groove portion 122a in the casing cover 2. Oil ejected from the second suction port 25 is sent to the pump accommodation portion 120 through the second suction groove portion 221. Further, the second suction port 25 is disposed to face the first ejection port 16 in the X direction. Here, the first ejection port 16 and the second suction port 25 may communicate with each other inside the straight groove portion 122a.

The second ejection port 26 is disposed in the Y2 direction with respect to the pump chamber PO. The second ejection port 26 is an opening through which oil is ejected from the pump chamber PO and opens in the X2 direction at a position facing the straight groove portion 121a in the casing cover 2. Oil ejected from the pump accommodation portion 120 is ejected to the second ejection passage 27 through the second ejection groove portion 222. Further, the second ejection port 26 is disposed to face the first suction port 15 in the X direction. Here, the first suction port 15 and the second ejection port 26 may communicate with each other inside the straight groove portion 121a.

The second ejection passage 27 is a passage which carries oil from the second ejection port 26. The second ejection passage 27 extends to the side opposite to the first suction passage 13 (the Z1 direction) with respect to the straight groove portion 121a. The second ejection passage 27 includes a second ejection first passage 27a, a second ejection second passage 27b, and a second ejection port 27c.

The second ejection first passage 27a is a passage which carries oil ejected from the second ejection port 26 in the Z1 direction. The second ejection first passage 27a communicates with the second ejection second passage 27b. The second ejection first passage 27a is provided with a second ejection passage check valve 28.

The second ejection passage check valve 28 has the same configuration as that of the first suction passage check valve 14 except that the second ejection passage check valve is provided in the second ejection first passage 27a and includes a ball B, a seating portion S, and a pin P.

The second ejection second passage 27b is a passage which carries oil supplied from the second ejection first passage 27a in the Y1 direction. The second ejection second passage 27b communicates with the second ejection port 27c.

The second ejection port 27c is an opening formed in the casing cover 2 and opens in the X2 direction. Oil ejected from the second ejection port 27c is pressure-fed from the oil outlet 1B to a lubricating member of a differential gear or the like. Further, the second ejection port 27c is disposed to be able to communicate with the first ejection port 17c in a facing state.

The first suction port 15, the first ejection port 16, the second suction port 25, and the second ejection port 26 have the same height (the same position in the Z direction). In this embodiment, the centers of the first suction port 15, the first ejection port 16, the second suction port 25, and the second ejection port 26 are aligned in the Z direction. Here, the first suction port 15, the first ejection port 16, the second suction port 25, and the second ejection port 26 may be disposed so that at least a part of them overlap one another in the Z direction.

<Pump Unit 3>

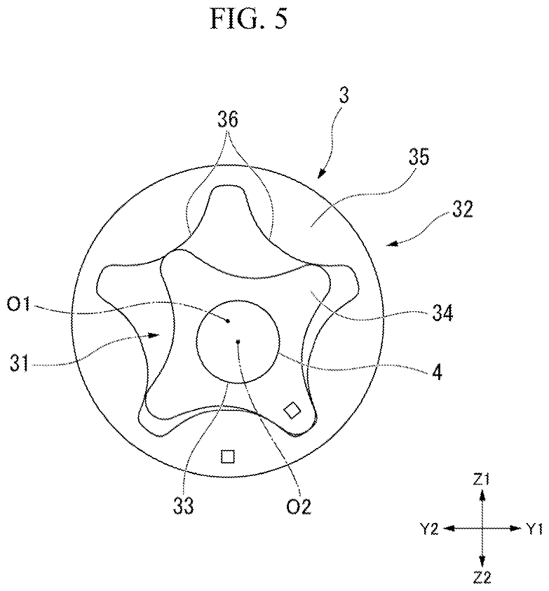

FIG. 5 is a front view of the pump unit 3.

The pump unit 3 is accommodated in the pump accommodation portion 120 of the pump chamber PO. The pump unit 3 sends out oil by rotating inside the pump chamber PO in accordance with the rotation of the rotation shaft 4. The pump unit 3 includes an inner rotor 31 and an outer rotor 32. The inner rotor 31 and the outer rotor 32 accommodated in the pump accommodation portion 120 constitute a so-called trochoid type (internal gear) pump.

The inner rotor 31 is formed in a cylindrical shape so as to be disposed coaxially with the axis O2 corresponding to the center axis of the rotation shaft 4. The inner rotor 31 includes an inner cylinder portion 33 and external teeth 34. The inner cylinder portion 33 is disposed on the inside of the outer rotor 32 inside the pump accommodation portion 120. The external teeth 34 are formed on the outer peripheral surface of the inner cylinder portion 33. The external teeth 34 are formed along, for example, a trochoidal curve or a combination of ellipses.

The outer rotor 32 is formed in a cylindrical shape to be disposed coaxially with the axis O1. The outer rotor 32 includes an outer cylinder portion 35 and internal teeth 36. The outer cylinder portion 35 is accommodated inside the pump accommodation portion 120. The outer cylinder portion 35 is formed to be slidable and slightly smaller than the inner peripheral surface of the pump accommodation portion 120. That is, the outer rotor 32 is supported by the inner peripheral surface of the pump accommodation portion 120 to be rotatable around the axis O1. The internal teeth 36 are formed on the inner peripheral surface of the outer cylinder portion 35. The internal teeth 36 are formed along, for example, a trochoidal curve or an envelope of a trochoidal curve or the like. The number of teeth of the external teeth 34 is one less than the number of teeth of the internal teeth 36.

<Operation of Oil Pump 100>

Next, an operation of the oil pump 100 will be described.

When the rotation shaft 4 rotates clockwise around the axis O2 as viewed from the X2 direction in accordance with the rotation of the propeller shaft, the inner rotor 31 rotates clockwise around the axis O2 along with the rotation shaft 4. Then, the outer rotor 32 rotates clockwise around the axis O1 as viewed from the X2 direction while engaging with the inner rotor 31.

The volume of the void formed between the inner rotor 31 and the outer rotor 32 gradually increases in the phase of the first suction port 15 to generate a negative pressure and the oil O is sucked from the first suction port 15 to the pump chamber PO. Oil O pumped from the first suction port 13a passes through the first suction passage check valve 14 in the Z1 direction to be carried to the first suction port 15.

Further, the volume of the void gradually decreases in the phase of the first ejection port 16 and the oil O is ejected from the pump chamber PO through the first ejection port 16. The oil O ejected from the first ejection port 16 passes through the first ejection passage check valve 18 in the Z1 direction to be carried to the first ejection port 17c.

At this time, the direction of the hydraulic pressure acting on the second suction passage 23 and the second ejection passage 27 is opposite to the direction of the hydraulic pressure acting on the first suction passage 13 and the first ejection passage 17. For that reason, the second suction passage check valve 24 and the second ejection passage check valve 28 are maintained in a closed state due to the hydraulic pressure of the oil O or the own weight of the ball B. That is, the oil O is not sucked from the second suction port 25 and the oil O is not ejected from the second ejection port 26.

On the other hand, when the rotation shaft 4 rotates counterclockwise around the axis O2 as viewed from the X2 direction, the inner rotor 31 rotates counterclockwise around the axis O2 along with the rotation shaft 4. Then, the outer rotor 32 rotates counterclockwise around the axis O1 as viewed from the X2 direction while engaging with the inner rotor 31.

The volume of the void gradually increases in the phase of the second suction port 25 to generate a negative pressure and the oil O is sucked from the second suction port 25 to the pump chamber PO through the straight groove portion 121a. The oil O pumped from the second suction port 23a passes through the second suction passage check valve 24 in the Z1 direction to be carried to the second suction port 25.

Further, the volume of the void gradually decreases in the phase of the second ejection port 26 and the oil O is ejected from the pump chamber PO through the second ejection port 26. The oil O ejected from the second ejection port 26 passes through the second ejection passage check valve 28 in the Z1 direction to be carried to the second ejection port 27c.

At this time, the direction of the hydraulic pressure acting on the first suction passage 13 and the first ejection passage 17 is opposite to the direction of the hydraulic pressure acting on the second suction passage 23 and the second ejection passage 27. For that reason, the first suction passage check valve 14 and the first ejection passage check valve 18 are maintained in a closed state due to the hydraulic pressure of the oil O or the own weight of the ball B. That is, the oil O is not sucked from the first suction port 15 and the oil O is not ejected from the first ejection port 16.

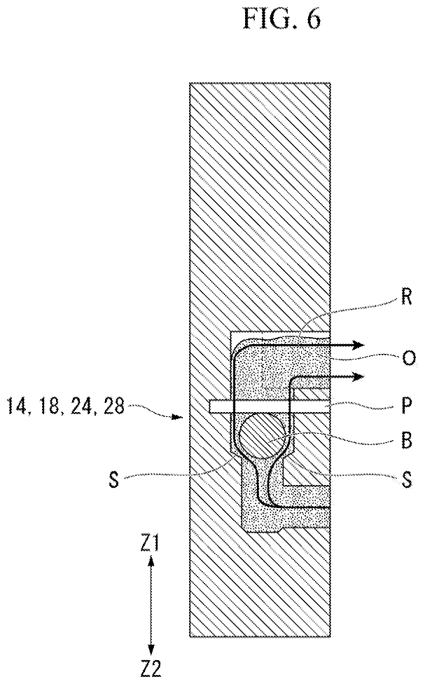

FIG. 6 is a diagram showing the first ejection passage check valve 18 or the like through which oil passes in the Z1 direction.

When the pump unit 3 rotates clockwise, the oil O passing through the first ejection passage check valve 18 or the like in the Z1 direction floats the ball B in contact with the seating portion S upward so that a path R for pumping the oil O upward is secured. On the other hand, when the oil O does not flow or the oil O tries to flow in the Z2 direction when the pump unit 3 rotates counterclockwise, the ball B comes into contact with the seating portion S due to the own weight of the ball B or the hydraulic pressure in the Z2 direction to prevent (suppress) the backflow of the oil O in the Z2 direction.

As shown in FIG. 3, the circumferential angle α of the arc groove portion 121b is larger than the circumferential angle β of the arc groove portion 122b. For that reason, when the rotation shaft 4 rotates clockwise around the axis O2 as viewed from the X2 direction, the ejection performance is higher than in a case in which the rotation shaft 4 rotates counterclockwise around the axis O2. That is, the ejection performance is different between the forward rotation case and the backward rotation case of the rotation shaft 4. For example, the ejection performance of the oil pump 100 in a forward traveling state of an automobile may be set to be high and the ejection performance thereof in a backward traveling state may be set to be low.

According to the oil pump 100 of this embodiment, the oil pump 100 can pressure-feed oil regardless of whether the rotation shaft 4 rotates forward or backward. Further, the first ejection passage check valve 18 or the like having a simple structure is used in the oil path along the vertical direction as the oil check valve, parts requiring a large space such as a spring are not required, and hence space saving can be realized.

According to the oil pump 100 of this embodiment, the first suction port 15, the first ejection port 16, the second suction port 25, and the second ejection port 26 have the same height (the same position in the Z direction). For that reason, the oil pump 100 can shorten the dimension in the height direction (the Z direction) compared to a case in which the four ports have different heights.

According to the oil pump 100 of this embodiment, the first suction port 15 and the first ejection port 16 are formed on both sides with the pump chamber PO interposed therebetween and the second suction port 25 and the second ejection port 26 are formed on both sides with the pump chamber PO interposed therebetween. For that reason, the oil pump 100 can arrange the four ports in a well-balanced manner and decrease the entire dimension.

According to the oil pump 100 of this embodiment, the first suction port 15 and the first ejection port 16 are provided in the casing main body 1 and the second suction port 25 and the second ejection port 26 are provided in the casing cover 2. For that reason, the oil pump 100 can realize space saving compared to a case in which all of the four ports are provided in any one of the casing main body 1 and the casing cover 2.

According to the oil pump 100 of this embodiment, at least one of the first suction passage check valve 14, the first ejection passage check valve 18, the second suction passage check valve 24, and the second ejection passage check valve 28 is provided in the passage that carries the oil O in the vertical direction. For that reason, since the ball B constituting the check valve moves to the seating portion S by itself due to the own weight, the configuration of the check valve can be simplified.

### Second Embodiment

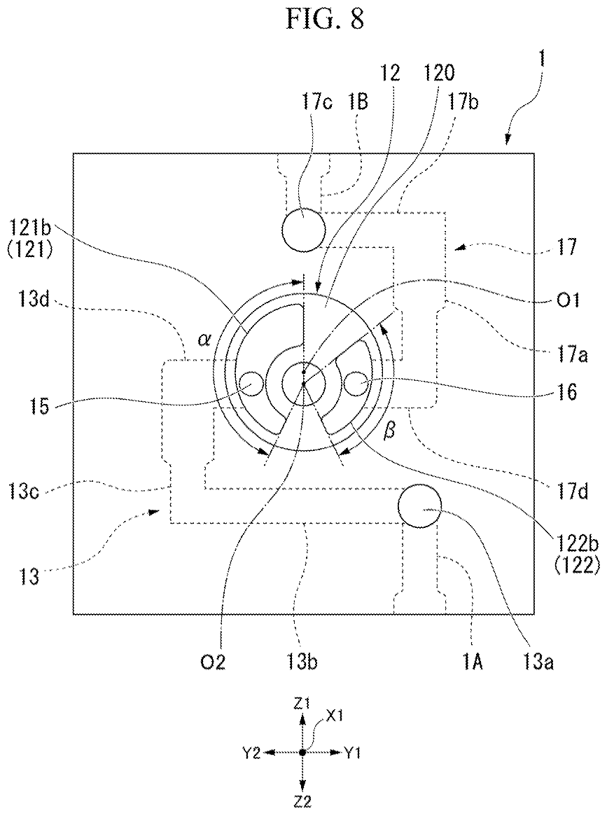

Next, a second embodiment will be described with reference to FIGS. 8, 9, and 10. Additionally, in the second embodiment to be described below, the configurations corresponding to the first embodiment will be denoted by the same reference numerals and the description thereof will be omitted.

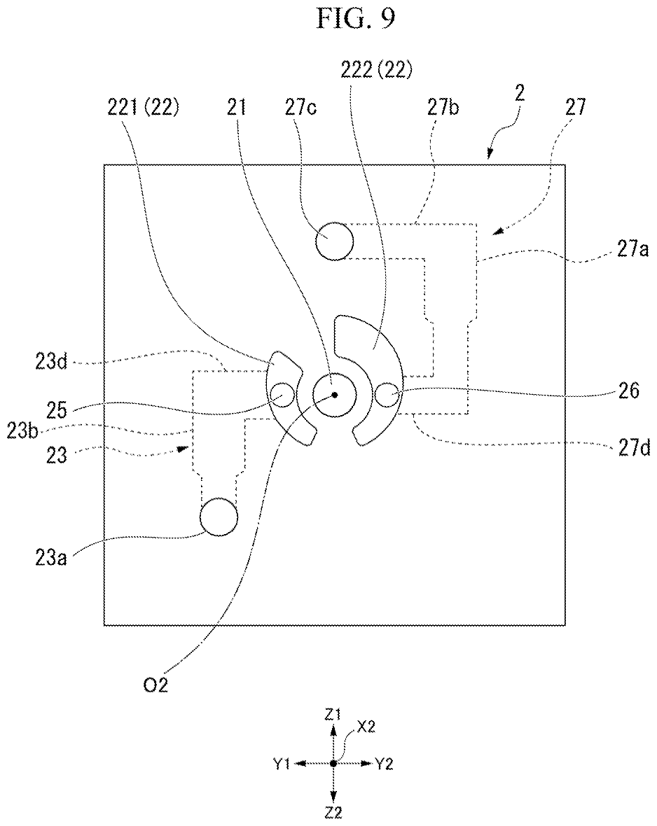

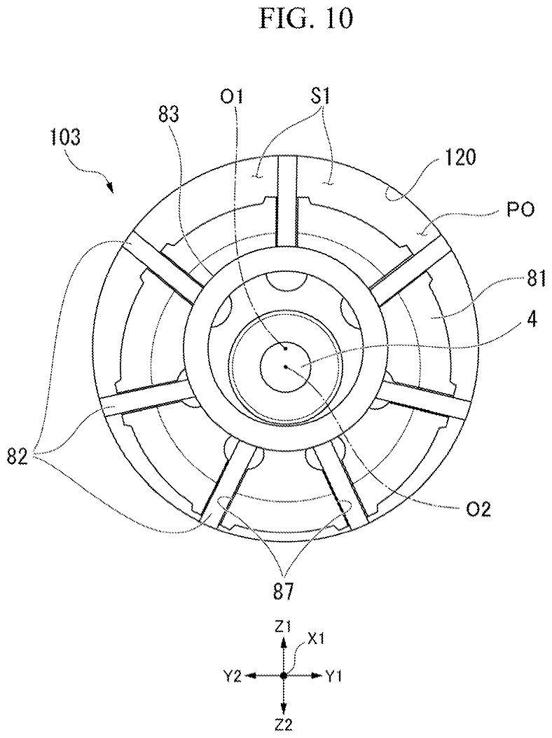

FIG. 8 is a front view of a casing main body as viewed from the side of the pump unit of the oil pump according to the second embodiment (the X1 direction). FIG. 9 is a front view of the casing cover as viewed from the side of the pump unit of the oil pump (the X2 direction). FIG. 10 is a front view of the pump unit of the oil pump.

As shown in FIG. 10, an oil pump 200 according to the second embodiment is a vane type oil pump. Specifically, a difference between the second embodiment and the first embodiment is that the configuration of a pump unit 103 of the second embodiment is different from the configuration of the pump unit 3 of the first embodiment.

In this embodiment, the pump unit 103 includes a rotor 81, a plurality of vanes 82, and a guide ring 83.

The rotor 81 is formed in a cylindrical shape to be disposed coaxially with the axis O2. The outer diameter of the rotor 81 is smaller than the inner diameter of the pump accommodation portion 120. The rotation shaft 4 is fixed into the pump accommodation portion 120 inside the rotor 81. That is, the rotor 81 rotates around the axis O2 inside the pump chamber PO in accordance with the rotation of the rotation shaft 4. The rotor 81 is provided with a plurality of slits 87 extending radially with respect to the axis O2. Each slit 87 opens to the outer peripheral surface of the rotor 81.

The vane 82 is separately accommodated in each slit 87 described above. Each vane 82 is slidable in the pump diameter direction orthogonal to the axis O2. The tip surface (the outer end surface in the pump diameter direction) of the vane 82 is slidable along the inner peripheral surface of the pump accommodation portion 120 in accordance with the rotation of the rotor 81.

The guide ring 83 is disposed on both sides in the X direction with respect to, for example, the rotor 81 inside the pump chamber PO (only one guide ring 83 is shown in FIG. 10). The guide ring 83 is disposed coaxially with the axis O1. The outer diameter of the guide ring 83 is smaller than the outer diameter of the rotor 81 and the inner diameter thereof is larger than the outer diameter of the rotation shaft 4. Both end portions of the rotation shaft 4 in the X direction (portions located on the outside in relation to the rotor 81) are inserted into the guide ring 83. An inner end surface of each vane 82 in the pump diameter direction is in contact with the outer peripheral surface of each guide ring 83. Thus, a plurality of fan-shaped transfer chambers S1 which are divided by the vanes 82 are formed between the rotor 81 and the inner peripheral surface of the pump accommodation portion 120. Additionally, an urging member that urges the vane 82 outward in the pump diameter direction may be provided inside each slit 87 instead of the guide ring 83 and the vane 82 may be urged outward in the pump diameter direction due to a back pressure.

As shown in FIG. 8, in this embodiment, the first suction port 15 opens in the X1 direction on the bottom surface of the arc groove portion 121b. Further, the first suction passage 13 includes a first connection passage 13d which connects the first suction port 15 to the first suction second passage 13c. The first connection passage 13d is formed in a straight shape along the Y direction inside the casing main body 1.

In this embodiment, the first ejection port 16 opens in the X1 direction on the bottom surface of the arc groove portion 122b. Further, the first ejection passage 17 includes a second connection passage 17d which connects the first ejection port 16 to the first ejection first passage 17a. The second connection passage 17d is formed in a straight shape along the Y direction inside the casing main body 1.

As shown in FIG. 9, in this embodiment, the second suction port 25 opens in the X2 direction on the bottom surface of the second suction groove portion 221. Further, the second suction passage 23 includes a third connection passage 23d which connects the second suction port 25 to the second suction first passage 23b. The third connection passage 23d is formed in a straight shape along the Y direction inside the casing cover 2.

In this embodiment, the second ejection port 26 opens in the X2 direction on the bottom surface of the second ejection groove portion 222. Further, the second ejection passage 27 includes a fourth connection passage 27d which connects the second ejection port 26 to the second ejection first passage 27a. The fourth connection passage 27d is formed in a straight shape along the Y direction inside the casing cover 2.

<Operation of Oil Pump 200>

Next, an operation of the oil pump 200 will be described.

When the rotation shaft 4 rotates around the axis O2 clockwise as viewed from the X2 direction, the rotor 81 rotates around the axis O2 clockwise along with the rotation shaft 4. Then, each vane 82 slides and moves in the pump diameter direction inside the slit 87 while sliding on the inner peripheral surface of the pump accommodation portion 120. Accordingly, the capacity (volume) of each transfer chamber S1 repeats expansion and compression continuously in accordance with the rotation of the rotor 81.

The capacity of the transfer chamber S1 gradually increases as the rotor 81 rotates and moves in the circumferential direction (clockwise around the axis O2) on the first suction groove portion 121 (the first suction port 15). A negative pressure is generated in the transfer chamber S1 in the process of increasing the capacity of the transfer chamber S1. Accordingly, the oil O inside the first suction passage 13 passes through the first suction port 15 and the oil O is sucked to the transfer chamber S1 (the pump chamber PO).

The capacity of the transfer chamber S1 gradually decreases as the rotor 81 rotates and moves in the circumferential direction (clockwise around the axis O2) on the first ejection groove portion 122 (the first ejection port 16). In the process in which the transfer chamber S1 decreases, the oil O inside the transfer chamber S1 is extruded and the oil O is ejected from the pump chamber PO to the first ejection passage 17 through the first ejection port 16.

At this time, the second suction passage check valve 24 and the second ejection passage check valve 28 are in a closed state, the oil O is not sucked from the second suction port 25, and the oil O is not ejected from the second ejection port 26.

On the other hand, when the rotation shaft 4 rotates around the axis O2 counterclockwise as viewed from the X2 direction, the rotor 81 rotates around the axis O2 counterclockwise along with the rotation shaft 4. Then, the oil O is sucked from the second suction port 25 and the oil O is ejected from the second ejection port 26.

At this time, the first suction passage check valve 14 and the first ejection passage check valve 18 are in a closed state, the oil O is not sucked from the first suction port 15, and the oil O is not ejected from the first ejection port 16.

The same operation and effect as those of the first embodiment are obtained even when the vane type pump unit 103 is used as in this embodiment. Since the vane type pump unit 103 can transfer the oil O at a high pressure even at a low-speed rotation, the hydraulic pressure can be appropriately controlled. Further, the vane type pump unit 103 is excellent in reducing pulsation.

Additionally, in this embodiment, a variable displacement type structure may be employed in which the axis O2 of the rotor 81 is movable with respect to the axis O1 of the pump chamber PO.

Although the embodiments of the present invention have been described above with reference to the drawings, a detailed configuration is not limited to these embodiments and design changes within the scope of the present invention are also included. Further, the components shown in the embodiments and the modified examples above can be appropriately combined.

(Modified Example 1)

For example, a case has been described such that a trochoid type (internal gear) oil pump is employed in the first embodiment and a vane type oil pump is employed in the second embodiment, but the type of the pump unit is not limited thereto. The pump unit can use a gear pump (external gear), a piston pump, or the like and the present invention has the same effect in any type. That is, the pump unit may include a rotating portion (for example, the inner rotor 31 or the rotor 81) fixed to the rotation shaft 4, for example, as in the trochoid type or the vane type and may send out the oil O by increasing and decreasing the capacity of the outer area of the rotating portion in accordance with the rotation of the rotating portion.

Further, the pump unit may include a plurality of rotation shafts crossing in parallel inside the pump chamber and a gear fixed to each rotation shaft as in the gear pump and may send out the oil P by engaging the gears in accordance with the rotation of each rotation shaft.

Further, the pump unit may include a rotation shaft provided at a position different from the pump chamber and a piston moving inside the pump chamber in accordance with the rotation of the rotation shaft as in the piston pump.

(Modified Example 2)

For example, in the above-described embodiment, all of the first suction passage 13, the first ejection passage 17, the second suction passage 23, and the second ejection passage 27 include the check valve having the ball B, the seating portion S, and the pin P, but the type of the check valve of the oil pump is not limited thereto. At least one of the first suction passage, the first ejection passage, the second suction passage, and the second ejection passage may include the check valve having the ball B, the seating portion S, and the pin P. A passage without the check valve in the four passages may be provided with a check valve having a different structure configured as a spring or the like.

(Modified Example 3)

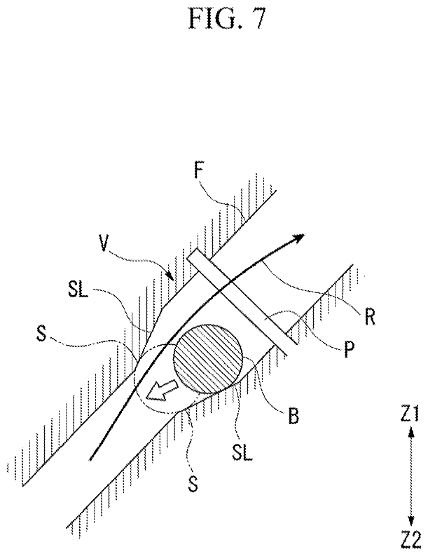

For example, in the above-described embodiment, the check valve having the ball B, the seating portion S, and the pin P is provided in the passage that carries the oil in the vertical direction, but the type of the check valve of the oil pump is not limited thereto. FIG. 7 is a diagram showing a check valve V which is a modified example of the check valve. The check valve V is provided in a passage F that carries oil in a direction inclined from the vertical direction. The check valve V includes the ball B, the seating portion S, the pin P, and an inclined surface SL. The inclined surface SL is an inclined surface similar to a conical inner peripheral surface and is provided between the seating portion S and the pin P. The inclined surface SL guides the ball B to the seating portion S. Since the seating portion S is located at a position lower than the lower end portion of the inclined surface SL in the X2 direction, the ball B naturally moves to the seating portion S due to gravity. The oil O passing through the check valve V upward floats the ball B in contact with the seating portion S upward so that the path R for pumping the oil O upward is secured. On the other hand, when the oil O does not flow or tries to flow downward, the ball B is guided by the inclined surface SL due to the own weight of the ball B or the hydraulic pressure to come into contact with the seating portion S so that the backflow of the oil O flowing downward is prevented (suppressed). Since the seating portion S is lower than the inclined surface SL even in the lowermost inclined surface SL, the ball B naturally moves to the seating portion S. The ball B moves to the seating portion S while being guided by the inclined surface SL due to the hydraulic pressure of the oil O or the own weight of the ball B. Thus, the ball B can be smoothly moved by the inclined surface SL. For this reason, the configuration of the check valve V can be simplified.

In this way, the check valve V can be appropriately provided in the passage having at least a vertical element in the oil carrying direction (the passage extension direction). Further, the check valve V may be provided in the passage extending in the horizontal direction if the check valve is operated only according to the hydraulic pressure of the oil O.

(Modified Example 4)

For example, in the above-described embodiment, the circumferential angle α of the arc groove portion 121b is larger than the circumferential angle β of the arc groove portion 122b and the ejection performance is different between the forward rotation case and the backward rotation case of the rotation shaft 4, but the type of the pump unit is not limited thereto. The circumferential angle α of the arc groove portion 121b may match the circumferential angle β of the arc groove portion 122b and the ejection performance may be the same between the forward rotation case and the backward rotation case of the rotation shaft 4.

(Modified Example 5)

For example, in the above-described embodiment, the external teeth 34 and the internal teeth 36 are formed in left-right symmetrical tooth shapes in which the peak shape and the valley shape are symmetrical in the circumferential direction, but the type of the external teeth and the internal teeth of the pump unit is not limited thereto. The external teeth and the internal teeth of the pump unit may be left-right asymmetrical to each other. When the external teeth and the internal teeth are left-right asymmetrical to each other, vibration and noise can be reduced under different conditions such as specific numbers of rotations when the rotation shaft 4 rotates in the forward direction and the backward direction.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

According to the oil pump of the present invention, it is possible to pressure-feed the oil regardless of whether the shaft rotates forward or backward and to realize space saving.

### EXPLANATION OF REFERENCES

100, 200 Oil pump

120 Pump accommodation portion

10 Casing

1 Casing main body

2 Casing cover

3 Pump unit

4 Rotation shaft

13 First suction passage

14 First suction passage check valve

15 First suction port

16 First ejection port

17 First ejection passage

18 First ejection passage check valve

23 Second suction passage

24 Second suction passage check valve

25 Second suction port

26 Second ejection port

27 Second ejection passage

28 Second ejection passage check valve

31 Inner rotor

32 Outer rotor

81 Rotor

82 Vane

83 Guide ring

PO Pump chamber

B Ball

S Seating portion

P Pin

1. An oil pump comprising:
a casing which is provided with a pump chamber;
a rotation shaft which is rotatably supported by the casing; and
a pump unit which is accommodated inside the pump chamber and is configured to send out oil inside the pump chamber in accordance with the rotation of the rotation shaft,
wherein the casing includes a first suction port which communicates with the pump chamber, a first suction passage which communicates with the first suction port, a first ejection port which communicates with the pump chamber, a first ejection passage which communicates with the first ejection port, a second, suction port which communicates with the pump chamber, a second suction passage which communicates with the second suction port, a second ejection port which communicates with the pump chamber, and a second ejection passage which communicates with the second ejection port,
wherein, w hen the pump unit rotates in one direction, the first suction port is configured to suck the oil from the first suction passage to the pump chamber and the first ejection port ejects the oil to the first ejection passage,
wherein, when the pump unit rotates in the other direction, the second suction port is configured to suck the oil from the second suction passage to the pump chamber and the second ejection port ejects the oil to the second ejection passage, and
wherein at least one of the first suction passage the first ejection passage, the second suction passage, and the second ejection passage includes a check valve provided in the oil carrying passage and the check valve includes a ball and seating portion allowing the ball to be seated thereon and does not spring.

2. The oil pump according to claim 1,
wherein the first suction port, the first ejection port, the second suction port, and the second ejection port are disposed at a position in which a vertical height is the same.

3. The oil pump according to claim 1,
wherein the first suction port and the first ejection port are disposed on both sides with the pump chamber interposed therebetween, and
wherein the second suction port and the second ejection port are disposed on both sides with the pump chamber interposed therebetween.

4. The oil pump according to claim 2,
wherein the first suction port and the first ejection port are disposed on both sides with the pump chamber interposed therebetween and
wherein the second suction port and the second ejection port are disposed on both sides with the pump chamber interposed therebetween.

5. The oil pump according to claim 1,
wherein the casing includes a casing main body and a casing cover,
wherein the pump chamber is formed between the casing main body and the casing cover,
wherein the first suction port and the first ejection port are provided in the casing main body, and
wherein the second suction port and the second ejection port are provided in the casing cover.

6. The oil pump according to claim 2,
wherein the casing includes a casing main body and a casing cover,
wherein the pump chamber is formed between the casing main body and the casing cover,
wherein the first suction port and the first ejection port are provided in the casing main body, and
wherein the second suction port and the second ejection port are provided in the casing cover.

7. The oil pump according to claim 3,
wherein the casing includes a casing main body and a casing cover,
wherein the pump chamber is formed between the casing main body and the casing cover,
wherein the first suction port and the first ejection port are provided in he casing main body, and
wherein the second suction port and the second ejection port are provided in the casing cover.

8. The oil pump according to claim 4,
wherein the casing includes a casing main body and a casing cover,
wherein the pump chamber is formed between the casing main body and the casing cover,
wherein the first suction port and the first ejection port are provided in the casing main body, and
wherein the second suction port and he second ejection port are provided in the casing cover.

9. The oil pump according to claim 1,
wherein at least one of the check valves is provided in, a passage that is configured to carry the oil in a vertical direction.

10. The oil pump according to claim 1,
wherein at least one of the check valves includes an inclined surface which is configured to guide the ball to the seating portion.

11. The oil pump according to claim 2,
wherein at least one of the check valves is provided in a passage that is configured to carry the oil in a vertical direction.

12. The oil pump according to claim 3,
wherein at least one of the check valves is provided in a passage that is configured to carry the oil in a vertical direction.

13. The oil pump according to claim 4,
wherein at least one of the check valves is provided in a passage that is configured to carry the oil in a vertical direction.

14. The oil pump according to claim 5,
wherein at least one of the check valves is provided in a passage that is configured to carry the oil in a vertical direction.

15. The oil pump according to claim 6,
wherein at least one of the check valves is provided in a passage that is configured to carry the oil in a vertical direction.

16. The oil pump according to claim 7,
wherein at least one of the check valves is provided in a passage that is configured to carry the oil in a vertical direction.

17. The oil pump according to claim 8,
wherein at least one of the check valves is provided in a passage that is configured to carry the oil in a vertical direction.

18. The oil pump according to claim 2,
wherein at least one of the check valves includes an inclined surface which is configured to guide the ball to the seating portion.

19. The oil pump according to claim 3,
wherein at least one of the check valves includes an inclined surface which is configured to guide the ball to the seating portion.

20. The oil pump according to claim 4,
wherein at least one of the check valves includes an inclined surface which is configured to guide the ball to the seating portion.
